(19) United States
(12) Patent Application Publication
(10) Pub. No.: US 2012/0281645 A1
(43) Pub. Date: Nov. 8, 2012

(54) METHOD AND APPARATUS FOR TRANSMITTING AN ACKNOWLEDGEMENT/NEGATIVE ACKNOWLEDGEMENT SIGNAL IN A RADIO COMMUNICATION SYSTEM

(75) Inventors: Yingyang LI, Beijing (CN); Chengjun SUN, Beijing (CN)

(73) Assignee: SAMSUNG ELECTRONICS CO. LTD., Suwon-si (KR)

(21) Appl. No.: 13/462,052

(22) Filed: May 2, 2012

(30) Foreign Application Priority Data
May 3, 2011 (CN) 201110117825.8

(51) Int. Cl. H04W 72/04

(52) U.S. Cl. 370/329

(57) ABSTRACT

A method and apparatus for transmitting an acknowledgement (ACK)/negative acknowledgement (NACK) signal in a radio communication system are provided. The method includes: a user equipment(UE) determines the number f ACK/NACK bits included in an ACK/NACK information based on an uplink (UL) downlink assignment indicator (DAI) in a physical downlink control channel (PDCCH), selects an encoding scheme, encodes the ACK/NACK bits using the encoding scheme; selects a scrambling code based on an ACK/NACK transmission mode configured in the UE in a single-Cell mode, and generates ACK/NACK signal by scrambling the encoded ACK/NACK bits; and transmits the ACK/NACK signal in a physical uplink shared channel (PUSCH).

### PRIORITY

This application claims priority under 35 U.S.C. §119(a) to a Chinese Patent Application filed in the State Intellectual Property Office of the People's Republic of China on May 3, 2011 and assigned Serial No. 201110117825.8, the entire disclosure of which is hereby incorporated by reference.

### BACKGROUND OF THE INVENTION

1. Field of the Technology

The present invention relates to wireless communications, and particularly, to a method and an apparatus for transmitting an acknowledgement (ACK)/negative acknowledgement (NACK) signal in a radio communication system.

2. Description of the Related Art

Long Term Evolution (LTE) systems adopt hybrid automatic repeat request (HARQ) for data transmission, i.e., a data receiving party transmits an ACK or an NACK according to the state of data reception as the feedback of the reception state. Scheduling information of dynamic downlink data transmission is transmitted via a physical downlink control channel (PDCCH). For semi-persistent scheduling (SPS) services, scheduling information for initial transmission of downlink data is not transmitted via PDCCH, and scheduling information for re-transmission of the downlink data is transmitted via PDCCH.

In LTE TDD systems, a downlink assignment indication (DAI) technique is developed to enable a user equipment (UE) to judge whether the UE has lost one or multiple PDCCH sent by a base station. Specifically, the DAI identifies a sequence number of a PDCCH in a downlink sub frame within the current binding window. A DAI field comprises 2 bits, thus has four possible values. In LTE TDD, the value of the DAI of the PDCCH increases from 1 to four in the order of the PDCCH being transmitted.

In LTE-Advanced (LTE-A), a carrier aggregation (CA) technique is adopted to support higher transmission data rate, i.e., two or more component carriers (CC) are aggregated for transmission to obtain a larger working bandwidth. According to CA, a base station transmits downlink data to a UE via two or more CC, and the UE needs to respond with ACK/NACK feedback information for the downlink data from the two or more CC. At present, an ACK/NACK is transmitted in a Pcell. Each CC is referred to as a cell.

According to current discussion result about LTE-A, the ACK/NACK fed back in a PUCCH may adopt channel selection and support transmission of at most 4 bits. A method of feeding back an ACK/NACK based on channel selection in an LTE-A TDD system adopts the above DAI design in the LTE. Firstly, multiple ACK/NACK to be transmitted via multiple PDCCH are sorted in an ascending order of the DAI value. If there is an SPS service, the ACK/NACK for the SPS service is placed at the first position. The number of consecutive ACK from the first position is fed back to each cell. The number of consecutive ACK is the ACK/NACK information that is fed back.

Specifically, if the size M of a binding window is 2, the number of consecutive ACK fed back to each cell has three possible values, i.e. 0, 1 or 2. The manner in Table 1 may be adopted to define four states which are mapped to 2 bits to fully utilize the feedback capacity of the 2 bits. If the size M of the binding window is three, the number of consecutive ACK fed back to each cell has four possible values, i.e. 0, 1, 2 or 3, which can be mapped to 2 bits in a one-to-one mapping manner, as shown in Table 2. If the size M of the binding window is four, the number of consecutive ACK fed back to each cell has five possible values, i.e. 0, 1, 2, 3 or 4. The five values can be converted into 4 states and mapped to 2 bits in a repeated mapping manner. One of the mapping manners may be as shown in Table 3. In the tables, “N” represents ‘NACK’, “A” represents “ACK”, “D” represents “DTX”, and the symbol “/” represents “or”.

TABLE 1

| at most three ACK/NACK in a binding window | state mapped to |
|---|---|
| A, A | A, A |
| N/D, A | N/D, A |
| A, N/D | A, N/D |
| N, N/D | N, N/D |
| D, any, any | D, N/D |

TABLE 2

| at most three ACK/NACK in a binding window | state mapped to |
|---|---|
| A, A, A | A, A |
| A, A, N/D | N/D, A |
| A, N/D, any | A, N/D |
| N, any, any | N, N/D |
| D, any, any | D, N/D |

TABLE 3

| at most four ACK/NACK in a binding window | state mapped to |
|---|---|
| A, A, A, N/D | A, A |
| A, A, N/D, any | N/D, A |
| A, A, A, A | A, N/D |
| or, A, D, D, D | |
| N, any, any, any | N, N/D |
| or, A, N/D, any, any except for A, D, D, D | |
| D, any, any, any | D, N/D |

According to the mapping manners in Tables 1, 2 and 3, 2 bits of information may be obtained for a Pcell and a Scell respectively, i.e., a total of four bits are obtained. Therefore, a four-bit-mapping table can be used for feeding back ACK/NACK according to the channel selection manner.

If there is a physical uplink shared channel (PUSCH), the ACK/NACK is multiplexed to the PUSCH for transmission in a manner according to LTE TDD. According to LTE TDD, if the PUSCH is dynamically scheduled by a PDCCH, an uplink (UL) DAI field in the PDCCH indicates a total number of sub frames including sub frames for transmitting downlink data sent by the current base station and sub frames released by SPS services. If an ACK/NACK is fed back in PUCCH based on channel selection according to LTE TDD, if the ACK/NACK is transmitted in a PUSCH, a UE obtains information about the number of bits of the ACK/NACK to be fed back according to the value of the UL DAI, encodes the ACK/NACK bits based on the information, and determines the number of resource elements (RE) in the PUSCH for transmitting the ACK/NACK.

According to current LTE-A discussions, if a UE is configured with the CA mode, one manner defines that the UL DAI indicates the maximum number of sub frames needed for feeding back ACK/NACK in each Cell. As shown in FIG. 1, a base station transmits three sub frames of data in a Pcell, and DL DAI in the sub frames are set to be 1, 2 and 3 respectively. The base station also transmits two sub frames of data in a Scell, with the DL DAI in the sub frames set to be 1 and 2. Therefore, if the base station schedules a dynamic PUSCH in a corresponding uplink sub frame, the UL DAI field of the PDCCH for scheduling uplink transmission is set to be 3.

In current LTE-A discussions, a manner of transmitting ACK/NACK in a PUSCH includes: performing space binding on multiple ACK/NACK for data in multiple sub frames of each Cell, and selecting a manner for presenting the ACK/NACK of each Cell according to the value of the UL DAI. Specifically, if the UL DAI is 1, 2 bits are generated with each bit for an ACK/NACK bit spatially bound with one Cell, and the 2 bits of ACK/NACK are transmitted in the PUSCH; if the UL DAI is 2, 3 or 4, 2 bits are generated for each Cell according to the manner in Table 1, Table 2 or Table 3 to get a total of 4 bits of ACK/NACK, and the 4 bits of the ACK/NACK are transmitted in the PUSCH.

In LTE-A, if a base station configures or re-configures the CA mode of a UE, e.g., changing configurations of the UE from single-Cell to multi-Cell, or changing configurations of the UE from multi-Cell to single-Cell, the base station may be not aware of whether the UE has shifted to the CA mode within a certain time period. The transmission manner of ACK/NACK is required to enable normal communication to be maintained during that time period. Currently, it is relied on the base station to avoid ACK/NACK confusions if PUCCH is used. For example, no matter the UE is in the single-Cell mode or the CA mode, the ACK/NACK fed back in the two modes should be the same during the time period as long as the base station transmits PDSCH only in the Pcell and only transmits one PDSCH which does not uses MIMO, to avoid confusion of ACK/NACK. As for the method adopting PUSCH, there is still no method of transmitting an ACK/NACK via a PUSCH can avoid the confusion of ACK/NACK.

### SUMMARY OF THE INVENTION

The present invention provides a method and apparatus for transmitting an ACK/NACK in a PUSCH which can avoid confusion of ACK/NACK and enhance performances of downlink data transmission.

The technical scheme of the present invention is described as follows.

A method for transmitting an acknowledgement (ACK)/negative acknowledgement (NACK) signal by a user equipment (UE) in a radio communication system may include: determining the number of ACK/NACK bits included in an ACK/NACK information based on an uplink (UL) downlink assignment indicator (DAI) in a physical downlink control channel (PDCCH), selecting an encoding scheme, encoding the ACK/NACK bits using the encoding scheme; selecting a scrambling code based on an ACK/NACK transmission mode configured in the UE in a single-Cell mode, and generating ACK/NACK signal by scrambling the encoded ACK/NACK bits; and transmitting the ACK/NACK signal in a physical uplink shared channel (PUSCH).

A user equipment (UE) in a radio communication system may include: a control unit for performing a control operation to determine the number of acknowledgement (ACK)/negative acknowledgement (NACK) bits included in an ACK/NACK information based on an uplink (UL) downlink assignment indicator (DAI) in a physical downlink control channel (PDCCH), select an encoding scheme, encode the ACK/NACK bits using the encoding scheme, select a scrambling code based on an ACK/NACK transmission mode configured in the UE in a single-Cell mode, and generate ACK/NACK signal by scrambling the encoded ACK/NACK bits; and a transmission unit for transmitting the ACK/NACK signal in a physical uplink shared channel (PUSCH).

### BRIEF DESCRIPTION OF THE DRAWINGS

FIG. 1 is an example of a base station scheduling downlink data transmission.

FIG. 2 illustrates an encoding chain of a UE which is configured with an ACK/NACK multiplexing mode of LTE.

FIG. 3 illustrates an encoding chain of a UE which is configured with an ACK/NACK binding mode and a SIMO mode of LTE.

FIG. 4 illustrates an encoding chain of a UE which is configured with an ACK/NACK binding mode and a MIMO mode of LTE.

FIG. 5 illustrates an encoding chain of a UE in a CA mode if UL DAI is 1.

FIG. 6 illustrates an encoding chain of a UE in a CA mode if UL DAI is 1.

FIG. 7 illustrates an encoding chain of a UE in a CA mode according to an embodiment of the present invention.

FIG. 8 illustrates an encoding chain of a UE in a CA mode according to an embodiment of the present invention.

FIG. 9 illustrates an encoding chain of a UE in a CA mode according to an embodiment of the present invention.

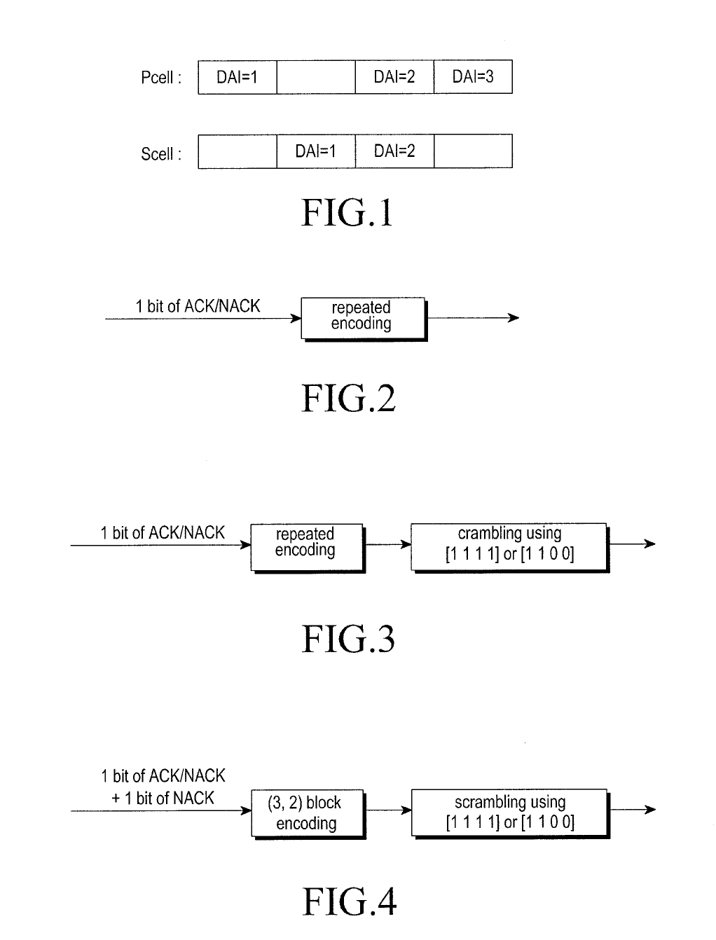

### DETAILED DESCRIPTION OF THE INVENTION

A detailed description of examples is hereinafter given with reference to specific implementations and the accompanying drawings.

The present invention provides a method for transmitting an ACK/NACK in a PUSCH. The method may include: a base station assigns PUSCH resources for a UE and transmits scheduling information of the PUSCH resources via a PDCCH; the UE determines the number of bits of an ACK/NACK based on an UL DAI in the PDCCH, selects an encoding scheme, encodes the ACK/NACK using the encoding scheme; selects a scrambling code based on an ACK/NACK transmission mode configured by the UE for a single-Cell mode, and scrambles the encoded ACK/NACK; the UE transmits the scrambled ACK/NACK via a PUSCH.

In the above method, if the UL DAI equals 1, ACK/NACK information of each Cell is processed with space binding into 1 bit, thus 2 bits of ACK/NACK information is obtained; or, an ACK/NACK of at most 4 bits are obtained according to a method adopted if the size M of a binding window of a PUCCH equals 1 without performing space binding. If the UL DAI equals 2, a method adopted if the size M of a binding window of the PUCCH equals 2 is adopted and space binding is performed to obtain an ACK/NACK of 4 bits. If the UL DAI equals 3 or 4, time binding and space binding are performed to obtain an ACK/NACK of 4 bits.

According to the method, the scrambling may be performed only if the UL DAI equals 1, or may be performed for all values of the UL DAI.

According to the method, if the ACK/NACK transmission mode configured in the UE in the single-Cell mode is a multiplexing mode, the scrambling code selected may be [0 0 0 0]; if the ACK/NACK transmission mode configured in the UE in the single-Cell mode is a binding mode, the scrambling code selected may be [1 1 1 1].

Alternatively, if the ACK/NACK transmission mode configured in the UE in the single-Cell mode is a multiplexing mode, the scrambling code selected may be [0 0 0 0]; if the ACK/NACK transmission mode configured in the UE in the single-Cell mode is a binding mode and the UE has received a physical downlink shared channel (PDSCH), the scrambling code selected may be [1 1 1 1]; if the ACK/NACK transmission mode configured in the UE in the single-Cell mode is a binding mode and the UE has not received a PDSCH, the scrambling code selected may be [1 1 0 0].

Or, if the ACK/NACK transmission mode configured in the UE in the single-Cell mode is a multiplexing mode, the scrambling code selected may be [0 0 0 0]; if the ACK/NACK transmission mode configured in the UE in the single-Cell mode is a binding mode, the scrambling code may be selected according to the value of the UL DAI.

Or, if the ACK/NACK transmission mode configured in the UE in the single-Cell mode is a multiplexing mode, the scrambling code selected may be [0 0 0 0]; if the ACK/NACK transmission mode configured in the UE in the single-Cell mode is a binding mode, a scrambling code may be selected according to the value of the UL DAI if the UE finds no PDCCH is missing, or another scrambling code may be selected according to the value of the UL DAI if the UE finds a PDCCH is missing.

The technical scheme will be described in detail with reference to some examples.

According to current provisions, if the size M of a binding window in a PUCCH equals 1, the number of bits to be fed back may be determined based on the transmission mode of each Cell. Therefore, the number of bits of an ACK/NACK in the binding window of two Cells equals or is smaller than 4, and the 4 bits of ACK/NACK may be directly fed back. If M equals 2, the number of bits to be fed back is 4 if the two Cells are both configured with SIMO, or 4 bits may be obtained through space binding if one or two Cells are configured with MIMO, and the 4 bits are fed back. If M equals 3 or 4, since the number of bits of the ACK/NACK is still larger than 4 even after the space binding, the time binding as shown in Table 2 and Table 3 may be adopted to map the ACK/NACK of each Cell to 2 bits to get a total of 4 bits, and the 4 bits of ACK/NACK is fed back.

Suppose the UL DAI field in a PDCCH which schedules a PUSCH is for indicating the maximum number of sub frames for which ACK/NACK information needs to be fed back within the two Cells. An embodiment of the present invention proposes using the method of processing ACK/NACK if the size of a binding window in the PUCCH is N_{DAI}^{UL} based on the value of the UL DAI field N_{DAI}^{UL} for generating the bits to be fed back for the 2 Cells. Specifically, if the UL DAI equals 1, the method adopted if the size M of a binding window of the PUCCH equals 1 is adopted, i.e., determining the number of bits to be fed back according to a transmission mode of each Cell without performing space binding, and transmitting an ACK/NACK of at most 4 bits in the PUSCH directly. If the UL DAI equals 2, the method adopted if M of the PUCCH equals 2 is adopted, i.e., performing space binding on ACK/NACK information of a Cell adopted MIMO to obtain an ACK/NACK of 4 bits. If the UL DAI equals 3, the method adopted if M of the PUCCH equals 3 is adopted. If the UL DAI equals 4, the method adopted if M of the PUCCH equals 4 is adopted, i.e., mapping ACK/NACK information of each cell to two bits to obtain a total of 4 bits of ACK/NACK, and feeding back the ACK/NACK of 4 bits.

If the base station is configuring or re-configuring the CA mode of a UE, e.g., changing the configuration from single-Cell to multi-Cell, or changing the configuration from multi-Cell to single-Cell, the base station may be unaware of whether the UE has shifted to the CA mode within a certain time period, i.e., the base station is not sure which format is being used by the UE for transmitting the ACK/NACK. For PUCCH, no matter whether the UE is in the single-Cell mode or the CA mode, the format of the ACK/NACK fed back in the two modes are the same as long as the base station transmits a PDSCH only in the Pcell and only transmits one PDSCH without using MIMO, thus state confusion can be avoided. According to an embodiment of the present invention, if the ACK/NACK is transmitted via a PUSCH, it is also required that a base station can obtain a correct ACK/NACK after decoding the PUSCH if the base station transmits the PDSCH only in the Pcell and transmits only one PDSCH without using MIMO. Therefore, according to embodiments of the present invention, the method transmits PDSCH while eliminating confusion of ACK/NACK fed back in the PUSCH, thus maintains the ongoing uplink and downlink communications. The scheduling strategy adopted by the base station for CA configuration and re-configuration may be determined by practical needs of the base station, and is not restricted in the present invention. According to the supposition, the UL DAI in the PDCCH which schedules the PUSCH is set to be 1 because the base station transmits only one PDSCH in the Pcell.

Supposing the UE is currently in the single-Cell mode, FIG. 2 illustrates an ACK/NACK encoding scheme adopted if the UE is configured with an ACK/NACK multiplexing mode, i.e., the 1 bit of ACK/NACK for each sub frame is fed back in the PUCCH by utilizing channel selection and the ACK/NACK is transmitted in PUSCH. The UL DAI equals 1, which indicates 1 bit of ACK/NACK needs to be transmitted by the UE in a PUSCH, thus the encoding scheme is repeated encoding. Therefore, the coded sequence of NACK/DTX is 000000000000 . . . , and the coded sequence of ACK is 111111111111 . . . .

Suppose the UE is currently in the single-Cell mode, and the UE is configured with an ACK/NACK binding mode, i.e., one bit of binding ACK/NACK is fed back via a PUCCH for each codeword. FIG. 3 illustrates an ACK/NACK encoding scheme adopted if a UE is configured with SIMO. The encoding scheme adopted is repeated encoding because the UE feeds back only 1 bit of binding ACK/NACK. In order to specify whether the UE has missed the last several PDSCHs in a binding window, LTE adopts scrambling. According to LTE TDD, since the UL DAI equals 1, the scrambling code adopted if the UE has received the PDSCH is [1 1 1 1], and the scrambling code adopted if the UE has not received the PDSCH is [1 1 0 0]. Therefore, the coded sequence of a NACK is 1111111111111 . . . , the coded sequence of an ACK is 000000000000 . . . , and the coded sequence of a DTX is 110011001100 . . . . FIG. 4 illustrates an ACK/NACK encoding scheme adopted if a UE is configured with MIMO. The UE needs to feed back 2 bits of binding ACK/NACK, so the encoding scheme adopted is (3, 2) block encoding. According to LTE, denoting two inputting bits as b₀, b₁, the (3, 2) block encoding outputs 3 bits which are denoted as c₀, c₁, c₂, where c₀=b₀, c₁=b₁, c₂=(b₀+b₁)mod 2. Similar with situations adopting SIMO, in order to specify whether the UE has missed the last several PDSCHs in a binding window, LTE adopts scrambling. According to LTE TDD, since the UL DAI equals 1, the scrambling code adopted if the UE has received a PDSCH is [1 1 1 1], and the scrambling code adopted if the UE has not received a PDSCH is [1 1 0 0]. During the time period of uncertainty resulted from CA configuration or re-configuration, the base station schedules data only in the SIMO mode, thus the above b₁ is NACK. Thus, if b₀ is NACK, the coded sequence is 111111111111 . . . ; if b₀ is ACK, the coded sequence is 010010010010 . . . , the coded sequence of a DTX is 110011001100 . . . .

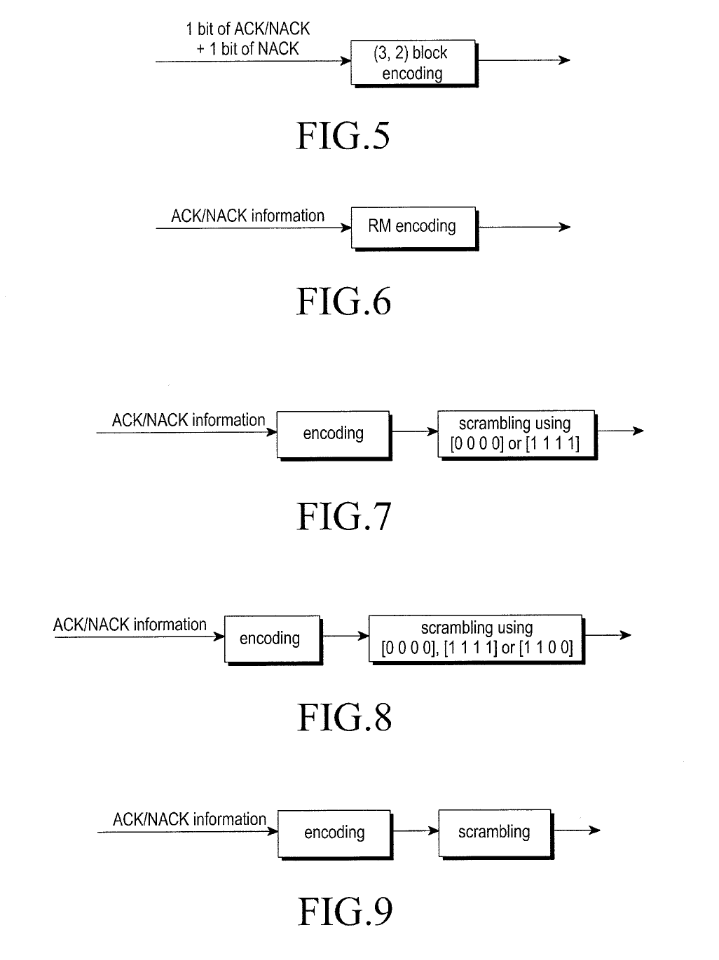

Supposing the UE is currently in the CA mode, FIG. 5 illustrates an ACK/NACK encoding scheme. Since the UL DAI equals 1, suppose the UE feeds back one bit of ACK/NACK for each Cell. Therefore, the UE needs to feed back two bits b₀, b₁ via a PUSCH, and (3, 2) block encoding is adopted. During the time period if state confusion may occur, the feedback bit b₀ for Pcell is the ACK/NACK of PDSCH; the bit b₁ for Scell is NACK/DTX, because according to the supposition, the UE does not transmit PDSCH in the Scell. Therefore, the coded sequence is 000000000000 . . . if b₀ is NACK, and the coded sequence of ACK is 101101101101 . . . if b₀ is ACK.

Supposing a UE is in the CA mode, another encoding scheme for encoding ACK/NACK is described in below. Since the UL DAI equals 1, according to a method adopted if the size M of a binding window of a PUCCH equals 1, the number of bits to be fed back is determined according to a transmission mode of each Cell without performing space binding. If the total number of bits is 2, the (3,2) block encoding as shown in FIG. 5 may be adopted. If the total number of bits is 3 or 4, the Reed-Mull encoding as shown in FIG. 6 may be adopted. In FIG. 6, input bits are denoted as b₀, b₁ . . . b_{c-1}, where C equals 3 or 4. According to the above supposition, during the time period if state confusion may occur, the base station only transmits one PDSCH in the Pcell using SIMO, thus b₀ is 1 bit of effective ACK/NACK, b₁, . . . b_{c-1} are all NACK/DTX. Therefore, if RM encoding scheme defined in LTE is adopted, the coded sequence is 000000000000 . . . if b₀ is NACK, and the coded sequence of ACK is 111111111111 . . . if b₀ is ACK.

If a UE in the single-Cell mode is configured with ACK/NACK multiplexing mode, the coded sequence of NACK is 000000000000 . . . . If the UE is in the CA mode, the coded sequence of NACK is also 000000000000 . . . according to the encoding manner shown in FIGS. 5 and 6. Therefore, if detecting a coded sequence of 000000000000 . . . , the base station obtains the same ACK/NACK information for the PDSCH even if the base station does not know whether the UE is in the single-Cell mode or in the CA mode, thus is less likely to have state confusion.

If a UE in the single-Cell mode is configured with ACK/NACK binding mode, the coded sequence of ACK is 000000000000 . . . . If the UE is in the CA mode, the coded sequence of NACK is also 000000000000 . . . according to the encoding manner shown in FIGS. 5 and 6. Therefore, the same coded sequence may have different meanings in the single-Cell mode and in the CA mode, which makes the base station difficult to identify an ACK/NACK, thus generates state confusion.

In order to solve the problem to reduce the chances of confusion, as shown in FIG. 7, an embodiment of the present invention adopts scrambling processing in the ACK/NACK encoding chain in the CA mode, and selects a scrambling code according to the ACK/NACK transmission mode configured in the UE in the single-Cell mode. Specifically, the encoding module in FIG. 7 selects the (3,2) block encoding or the RM encoding according to the number of bits determined based on the UL DAI, and uses a scrambling code of [0 0 0 0] if the UE in the single-Cell mode is configured with the ACK/NACK multiplexing mode, or uses a scrambling code of [1 1 1 1] if the UE in the single-Cell mode is configured with the ACK/NACK binding mode. In fact, an input bit sequence will not be changed after being scrambled with [0 0 0 0], thus this method equates with performing no scrambling if a UE in the single Cell mode is configured with ACK/NACK multiplexing mode, and performing scrambling using [1 1 1 1] if a UE in the single Cell mode is configured with ACK/NACK binding mode. The encoding chain shown in FIG. 7 may be used in situations if the UL DAI is 1, and if the UL DAI is not 1, no scrambling may be performed. Alternatively, the encoding chain shown in FIG. 7 may be used for any value of the UL DAI.

In an ACK/NACK encoding chain in the CA mode as shown in FIG. 8, another method of selecting a scrambling code according to the ACK/NACK transmission mode configured in a UE in the single Cell mode includes: using [0 0 0 0] as the scrambling code if the UE in the single Cell mode is configured with ACK/NACK multiplexing; using [1 1 1 1] as the scrambling code if the UE in the single Cell mode is configured with ACK/NACK binding and the UE has received the PDSCH; and using [1 1 0 0] as the scrambling code if the UE in the single Cell mode is configured with ACK/NACK binding and the UE has not received the PDSCH. In fact, an input bit sequence will not be changed after being scrambled with [0 0 0 0], thus this method equates with performing no scrambling if a UE in the single Cell mode is configured with ACK/NACK multiplexing mode, and performing scrambling using [1 1 1 1] or [1 1 0 0] if a UE in the single Cell mode is configured with ACK/NACK binding mode. The encoding chain shown in FIG. 8 may be used in situations if the UL DAI is 1, and if the UL DAI is not 1, no scrambling may be performed. Alternatively, the encoding chain shown in FIG. 8 may be used whatever the value of the UL DAI is.

In an ACK/NACK encoding chain in the CA mode as shown in FIG. 9, another method of selecting a scrambling code according to the ACK/NACK transmission mode configured in a UE in the single Cell mode includes: using [0 0 0 0] as the scrambling code if the UE in the single Cell mode is configured with ACK/NACK multiplexing; if the UE in the single Cell mode is configured with ACK/NACK binding, a scrambling code may be selected according to a value obtained by subtracting 1 from the value of the UL DAI, i.e., i=N_{DAI}^{UL}−1, as shown in Table 4.

TABLE 4

| i | scrambling code |
|---|---|
| 0 | [1 1 1 1] |
| 1 | [1 0 1 0] |
| 2 | [1 1 0 0] |
| 3 | [1 0 0 1] |

In fact, an input bit sequence will not be changed after being scrambled with [0 0 0 0], thus this method equates with performing no scrambling if a UE in the single Cell mode is configured with ACK/NACK multiplexing mode, and selecting a scrambling code according to i=N_{DAI}^{UL}−1 and Table 4 if the UE in the single Cell mode is configured with ACK/NACK binding mode.

In FIG. 9, the process may also be as follows. If the ACK/NACK transmission mode configured in the UE for the single-Cell mode is ACK/NACK multiplexing mode, the scrambling code selected may be [0 0 0 0]; if the ACK/NACK transmission mode configured in the UE for the single-Cell mode is ACK/NACK binding mode, a scrambling code may be selected according to a value obtained by subtracting 1 from the value of the UL DAI, i.e., i=N_{DAI}^{UL}−1 if the UE finds no PDCCH is missing, or another scrambling code may be selected according to a value obtained based on the value of the UL DAI and i=(N_{DAI}^{UL}+1)mod 4 if the UE finds a PDCCH is missing. In fact, an input bit sequence will not be changed after being scrambled with [0 0 0 0], thus this method equates with performing no scrambling if a UE in the single Cell mode is configured with ACK/NACK multiplexing mode, and if the UE in the single Cell mode is configured with ACK/NACK binding mode, selecting a scrambling code according to i=N_{DAI}^{UL}−1 if the UE finds no PDCCH is missing, and selecting a scrambling code according to i=(N_{DAI}^{UL}+1) mod 4 and Table 4 if the UE finds a PDCCH is missing.

Meanwhile, the UE may include a control unit (not shown in any figure), and a transmission unit (not shown in any figure), and perform an operation related to the described ACK/NACK signal transmission operation using the control unit and the transmission unit. For example, the control unit performs a control operation to determine the number of ACK/NACK bits included in the ACK/NACK information based on the UL DAI in the PDCCH, select the encoding scheme, encode the ACK/NACK bits using the encoding scheme, select the scrambling code based on the ACK/NACK transmission mode configured in the UE in the single-Cell mode, and generate the ACK/NACK signal by scrambling the encoded ACK/NACK bits. Further, for example, the transmission unit transmits the ACK/NACK signal in the PUSCH.

The foregoing are only preferred examples of the present disclosure and are not for use in limiting the protection scope thereof. All modifications, equivalent replacements or improvements in accordance with the spirit and principles of the present disclosure shall be included in the protection scope of the present disclosure.

What is claimed is:

1. A method for transmitting an acknowledgement (ACK)/negative acknowledgement (NACK) signal by a user equipment (UE) in a radio communication system, comprising:
determining the number of ACK/NACK bits included in an ACK/NACK information based on an uplink (UL) downlink assignment indicator (DAI) in a physical downlink control channel (PDCCH), selecting an encoding scheme, encoding the ACK/NACK bits using the encoding scheme;
selecting a scrambling code based on an ACK/NACK transmission mode configured in the UE in a single-Cell mode, and generating ACK/NACK signal by scrambling the encoded ACK/NACK bits; and
transmitting the ACK/NACK signal in a physical uplink shared channel (PUSCH).

2. The method of claim 1, wherein determining the number of ACK/NACK bits comprising:
if the UL DAI equals 1, determining an ACK/NACK of at most 4 bits by utilizing a method adopted if the size M of a binding window of a physical uplink control channel (PUCCH) equals 1 without performing space binding;
if the UL DAI equals 2, determining an ACK/NACK of 4 bits by performing space binding and utilizing a method adopted if the size M of a binding window of the PUCCH equals 2; and
if the UL DAI equals 3 or 4, determining an ACK/NACK of 4 bits by performing space binding and time binding.

3. The method of claim 1, wherein the scrambling is performed if the UL DAI equals 1, or the scrambling is performed for all values of the UL DAI.

4. The method of claims 1, wherein if the ACK/NACK transmission mode configured in the UE in the single-Cell mode is a multiplexing mode, the scrambling code selected is [0 0 0 0]; if the ACK/NACK transmission mode configured in the UE in the single-Cell mode is a binding mode, the scrambling code selected is [1 1 1 1].

5. The method of claim 3, wherein if the ACK/NACK transmission mode configured in the UE in the single-Cell mode is a multiplexing mode, the scrambling code selected is [0 0 0 0]; if the ACK/NACK transmission mode configured in the UE in the single-Cell mode is a binding mode, the scrambling code selected is [1 1 1 1].

6. The method of claim 1, wherein if the ACK/NACK transmission mode configured in the UE in the single-Cell mode is a multiplexing mode, the scrambling code selected is [0 0 0 0]; if the ACK/NACK transmission mode configured in the UE in the single-Cell mode is a binding mode and the UE has received a physical downlink shared channel (PDSCH), the scrambling code selected is [1 1 1 1]; if the ACK/NACK transmission mode configured in the UE in the single-Cell mode is the binding mode and the UE has not received a physical downlink shared channel (PDSCH), the scrambling code selected is [1 1 0 0].

7. The method of claim 3, wherein if the ACK/NACK transmission mode configured in the UE in the single-Cell mode is a multiplexing mode, the scrambling code selected is [0 0 0 0]; if the ACK/NACK transmission mode configured in the UE in the single-Cell mode is a binding mode and the UE has received a physical downlink shared channel (PDSCH), the scrambling code selected is [1 1 1 1]; if the ACK/NACK transmission mode configured in the UE in the single-Cell mode is the binding mode and the UE has not received a physical downlink shared channel (PDSCH), the scrambling code selected is [1 1 0 0].

8. The method of claim 1, wherein if the ACK/NACK transmission mode configured in the UE in the single-Cell mode is a multiplexing mode, the scrambling code selected is [0 0 0 0]; if the ACK/NACK transmission mode configured in the UE in the single-Cell mode is a binding mode, the scrambling code is selected according to the value of the UL DAI.

9. The method of claim 3, wherein if the ACK/NACK transmission mode configured in the UE in the single-Cell mode is a multiplexing mode, the scrambling code selected is [0 0 0 0]; if the ACK/NACK transmission mode configured in the UE in the single-Cell mode is a binding mode, the scrambling code is selected according to the value of the UL DAI.

10. The method of claim 1, wherein if the ACK/NACK transmission mode configured in the UE in the single-Cell mode is a multiplexing mode, the scrambling code selected is [0 0 0 0];
if the ACK/NACK transmission mode configured in the UE in the single-Cell mode is a binding mode, a scrambling code is selected according to the value of the UL DAI if the UE has found no PDCCH is missing, or another scrambling code is selected according to the value of the UL DAI if the UE has found a PDCCH is missing.

11. A user equipment (UE) in a radio communication system, comprising:
a control unit for performing a control operation to determine the number of acknowledgement (ACK)/negative acknowledgement (NACK) bits included in an ACK/NACK information based on an uplink (UL) downlink assignment indicator (DAI) in a physical downlink control channel (PDCCH), select an encoding scheme, encode the ACK/NACK bits using the encoding scheme, select a scrambling code based on an ACK/NACK transmission mode configured in the UE in a single-Cell mode, and generate ACK/NACK signal by scrambling the encoded ACK/NACK bits; and
a transmission unit for transmitting the ACK/NACK signal in a physical uplink shared channel (PUSCH).

12. The UE of claim 11, wherein the control unit determines an ACK/NACK of at most 4 bits by utilizing a method adopted if the size M of a binding window of a physical uplink control channel (PUCCH) equals 1 without performing space binding if the UL DAI equals 1, determines an ACK/NACK of 4 bits by performing space binding and utilizing a method adopted if the size M of a binding window of the PUCCH equals 2 if the UL DAI equals 2, and determines an ACK/NACK of 4 bits by performing space binding and time binding if the UL DAI equals 3 or 4.

13. The UE of claim 11, wherein the scrambling is performed if the UL DAI equals 1, or the scrambling is performed for all values of the UL DAI.

14. The UE of claims 11, wherein if the ACK/NACK transmission mode configured in the UE in the single-Cell mode is a multiplexing mode, the scrambling code selected is [0 0 0 0]; if the ACK/NACK transmission mode configured in the UE in the single-Cell mode is a binding mode, the scrambling code selected is [1 1 1 1].

15. The UE of claim 13, wherein if the ACK/NACK transmission mode configured in the UE in the single-Cell mode is a multiplexing mode, the scrambling code selected is [0 0 0 0]; if the ACK/NACK transmission mode configured in the UE in the single-Cell mode is a binding mode, the scrambling code selected is [1 1 1 1].

16. The UE of claim 11, wherein if the ACK/NACK transmission mode configured in the UE in the single-Cell mode is a multiplexing mode, the scrambling code selected is [0 0 0 0]; if the ACK/NACK transmission mode configured in the UE in the single-Cell mode is a binding mode and the UE has received a physical downlink shared channel (PDSCH), the scrambling code selected is [1 1 1 1]; if the ACK/NACK transmission mode configured in the UE in the single-Cell mode is the binding mode and the UE has not received a physical downlink shared channel (PDSCH), the scrambling code selected is [1 1 0 0].

17. The UE of claim 13, wherein if the ACK/NACK transmission mode configured in the UE in the single-Cell mode is a multiplexing mode, the scrambling code selected is [0 0 0 0]; if the ACK/NACK transmission mode configured in the UE in the single-Cell mode is a binding mode and the UE has received a physical downlink shared channel (PDSCH), the scrambling code selected is [1 1 1 1]; if the ACK/NACK transmission mode configured in the UE in the single-Cell mode is the binding mode and the UE has not received a physical downlink shared channel (PDSCH), the scrambling code selected is [1 1 0 0].

18. The UE of claim 11, wherein if the ACK/NACK transmission mode configured in the UE in the single-Cell mode is a multiplexing mode, the scrambling code selected is [0 0 0 0]; if the ACK/NACK transmission mode configured in the UE in the single-Cell mode is a binding mode, the scrambling code is selected according to the value of the UL DAI.

19. The UE of claim 13, wherein if the ACK/NACK transmission mode configured in the UE in the single-Cell mode is a multiplexing mode, the scrambling code selected is [0 0 0 0], if the ACK/NACK transmission mode configured in the UE in the single-Cell mode is a binding mode, the scrambling code is selected according to the value of the UL DAI.

20. The UE of claim 11, wherein if the ACK/NACK transmission mode configured in the UE in the single-Cell mode is a multiplexing mode, the scrambling code selected is [0 0 0 0],
if the ACK/NACK transmission mode configured in the UE in the single-Cell mode is a binding mode, a scrambling code is selected according to the value of the UL DAI if the UE has found no PDCCH is missing, or another scrambling code is selected according to the value of the UL DAI if the UE has found a PDCCH is missing.
